(19) United States
(12) Patent Application Publication
(10) Pub. No.: US 2009/0106004 A1
(43) Pub. Date: Apr. 23, 2009

(54) Systems and methods for evaluating interventions

(75) Inventors: Rogers A. Edwards, Boxborough, MA (US); Alan Karl Graham, Lexington, MA (US); Michael Martin Amati, Syracuse, NY (US); Melissa Kiriaki Williams, Boston, MA (US); Caroline Rachael Wright, Buckinghamshire (GB); Mei-Ching Lee, London (GB); Daniel Frederick Walsh, JR., Doylestown, PA (US); Nick Hughes, Peterborough (GB)

Correspondence Address: FOLEY AND LARDNER LLP;SUITE 500, 3000 K STREET NW, WASHINGTON, DC, 20007, US

(73) Assignee: PA Consulting Group

(21) Appl. No.: 12/285,920

(22) Filed: Oct. 16, 2008

Related U.S. Application Data
(60) Provisional application No. 60/960,869, filed on Oct. 17, 2007.

(51) Int. Cl. G06G 7/60

(52) U.S. Cl. 703/6

(57) ABSTRACT

A system and method for evaluating one or more interventions having a direct or indirect impact on a disease identification or a disease progression incorporating a causal framework to establish relationships among the disease, complications, and comorbidities. The system and method determines population groups and risk factors for the disease, complications, and comorbidities. The system and method structures and calibrates a simulation model of the relationships, population groups, and risk factors and characterizes interventions. The system and method analyzes the characterized interventions to determine the direct or indirect impact of the interventions on the disease identification or progression using the simulation model. An indication of the impact of the interventions is provided on an electronic display or to a memory device.

### CROSS-REFERENCE TO RELATED PATENT APPLICATIONS

This application claims priority to U.S. Provisional Application 60/960,869, filed Oct. 17, 2007, incorporated herein by reference in its entirety.

### BACKGROUND

The present disclosure relates generally to simulation models of patient populations of diseases or ailments, and more particularly to a causal simulation model for evaluating interventions for direct and indirect efficacy, effectiveness, and/or impact on disease identification and progression, for example as related to diabetes.

Diabetes and related complications and comorbidities (C&Cs) represent a significant and increasing health care burden. Absence of a systematic manner to evaluate value propositions of interventions may impede the best uses of current and emerging medical technologies.

Type 2 Diabetes represents a significant healthcare burden and its prevalence is continuing to rise at an alarming rate. In the United States, one out of every eight federal health care dollars (12.5%) is spent treating people with diabetes. The Center for Disease Control estimates that 20.8 million people in the US, representing 7% of the total population, have diabetes. Despite sustained efforts to control diabetes, prevalence is predicted to double by 2025, further increasing the already-high financial burden of diabetes.

The burden of diabetes is compounded by the increasing risks associated with its complications and comorbidities (C&Cs). The presence of diabetes increases the risk of over forty complications, including atherosclerosis, coronary heart disease and nephropathy. Indeed, forty percent of US deaths can be attributed, either directly or partially indirectly, to diabetes (through heart disease, stroke, diabetes, nephropathy, and hypertension). In addition, other comorbidities of diabetes, including obesity, hypertension, and dyslipidemia may, in turn, increase the risk of diabetes.

### SUMMARY

One embodiment of the disclosure relates to a method for evaluating one or more interventions using processing electronics. Each of the interventions has a direct or indirect impact on a disease identification or a disease progression. The method includes developing a causal framework to establish relationships among the disease, complications of the disease, and comorbidities of the disease. The relationships are based on information retrieved from at least one electronic data source. The method also includes determining population groups and risk factors for the disease, complications of the disease, and comorbidities of the disease. The population groups and risk factors are based on information retrieved from the at least one electronic data source. The method also includes structuring and calibrating a simulation model of the relationships, population groups, and risk factors. The method also includes characterizing interventions based on information retrieved from the at least one electronic data source. The method also includes analyzing the characterized interventions to determine the direct or indirect impact of the interventions on the disease identification or progression using the simulation model. The method also includes providing an indication of the impact of the interventions on an electronic display or memory device.

Another embodiment of the disclosure relates to an integrative simulation model architecture for representing the health status of a patient population with respect to multiple disease conditions, complications, and comorbidities. The architecture includes a data source configured to store information related to disease conditions and associated complications, and comorbidities. The architecture also includes a simulator configured to retrieve information stored on the data source and use the information to evaluate one or more interventions using processing electronics to determine a direct or indirect impact on a disease identification or a disease progression. The simulator stores an indication of the impact of the interventions on a memory device or provides an indication of the impact of the interventions to an electronic display.

Another embodiment of the disclosure relates to a simulator for evaluating one or more interventions to determine a direct or indirect impact on a disease identification or a disease progression. The simulator includes processing electronics configured to receive information from a data source and provide an indication of the direct or indirect impact to a memory device or display. The processing electronics are configured for evaluating direct and indirect consequences of interventions on overall patient population disease status, evaluating medical impacts on overall patient population disease status of future intervention developments, and evaluating impacts on overall patient population disease status of alternative demographics for a given intervention and determining differential impacts of interventions.

Another embodiment of the disclosure relates to an integrative simulation model architecture. The architecture includes processing electronics configured to receive information from a data source and provide an indication of the direct or indirect impact to a memory device or display. The processing electronics is further configured for analyzing and making inferences based on multiple outcome measures including death, patient quality of life, specific disease management measures, and costs. The processing electronics is further configured for linking outcome measures to analyses from multiple stakeholder perspectives including patient, physician, payer, society, technology developer, and others. The processing electronics is further configured for providing comprehensive, interconnected analyses that incorporate a range of health care system and management components, along with intervention-specific components. The processing electronics is further configured for linking disease burden forecasting to better mapping of interrelated clinical conditions.

These and other features and advantages of the present invention will be appreciated by a review of the following detailed description of the preferred embodiments taken in conjunction with the following drawings.

### BRIEF DESCRIPTION OF THE DRAWINGS

FIG. 1 is a block diagram illustrating the relationships among diabetes and a subset of diabetes C&Cs according to an exemplary embodiment.

FIG. 2 is a block diagram illustrating the inputs and outputs of a disease model simulator according to an exemplary embodiment.

FIG. 3 is a block diagram of the simulator of FIG. 2 according to an exemplary embodiment.

FIG. 4 is a block diagram of the simulator of FIG. 2 according to another exemplary embodiment.

FIG. 5 is a diagram illustrating an organization of diabetes and related C&Cs in the simulator of FIG. 2 according to an exemplary embodiment.

FIG. 6 is a diagram illustrating relationships among patient care variables within each disease or C&C according to an exemplary embodiment.

FIG. 7 is a flow chart illustrating a method for evaluating one or more interventions using the simulator of FIG. 2 according to an exemplary embodiment.

FIG. 8 is a flow chart illustrating a method for evaluating one or more interventions using the simulator of FIG. 2 according to another exemplary embodiment.

FIG. 9 is a flow chart illustrating a method for evaluating one or more interventions using the simulator of FIG. 2 according to another exemplary embodiment.

FIG. 10 is a flow chart illustrating a method for evaluating one or more interventions using the simulator of FIG. 2 according to another exemplary embodiment.

FIG. 11 is a flow chart illustrating a method for analyzing the characterized interventions in the simulator of FIG. 2 and in the method of FIG. 7 according to an exemplary embodiment.

FIG. 12 is a graph illustrating an impact on projections of diabetes prevalence when cross-linkages are incorporated according to an exemplary embodiment.

FIG. 13 includes graphs illustrating analyses ranking intervention impacts on death aversion and C&C aversion according to an exemplary embodiment.

FIGS. 14A-14C are graphs illustrating an impact of tailored adherence interventions for obesity on mortality according to an exemplary embodiment.

FIGS. 15A-15D illustrate how identification of high-impact interventions and investment opportunities enable acceleration of the trajectory of emerging interventions according to an exemplary embodiment.

### DETAILED DESCRIPTION OF THE EXEMPLARY EMBODIMENTS

The following exemplary discussion focuses on a causal population simulation model for evaluating entire portfolios of present and future interventions in terms of their direct and indirect efficacy, effectiveness, and/or impact on disease identification and progression. For purposes of this disclosure, an intervention can be introduced at point of a patient care cycle, for example by promoting awareness, diagnosing a disease, performing a treatment or treatment technology, performing therapy, monitoring a treatment, monitoring an intervention adherence, and/or identifying an outcome. For purposes of this disclosure, the term “technology” can refer to any system, device, procedure, or general knowledge that can be used in an intervention to influence or impact the progression of a disease and/or its complications and comorbidities (C&Cs), including diagnosis tests, medical devices, biopharmaceuticals, surgical procedures, lifestyle changes, and any intervention technologies that affect the healthcare system and patient care variables. The exemplary embodiments in the present disclosure can perform the evaluations, make inferences based on multiple outcome measures, and link those measures to analyses from the perspective of multiple stakeholders. Further, comprehensive, interconnected analyses that incorporate a range of health care system and management components, along with intervention-specific components, are provided.

According to various exemplary embodiments, a system dynamics methodology can be used to develop a generally comprehensive causal simulator of a population (e.g., a US or national population, a state population, a managed car plan population, etc.) and evaluate whether present and future interventions or entire portfolios of present and future interventions can be for direct and indirect impacts on a disease or ailment. An explicit semi-quantitative methodology can be used for surveying, prioritizing, and grouping C&Cs, patient subgroups, and interventions using generally diverse and publicly available clinical literature.

According to one exemplary embodiment, a model may simulate the incidence and prevalence of diabetes and its most commonly associated C&Cs (e.g., the ten most commonly associated C&Cs), reflecting upstream and downstream relationships among the disease and C&Cs. The simulator may enable systematic evaluation of tens of thousands of potential combinations of emerging interventions and leverage points that can be used to improve patient outcomes and guide intervention investments (e.g., technology investments). Feasibility can be demonstrated through single, pair-wise, and targeted analyses of interventions. It is noted that while a number of described examples and exemplary embodiments refer to diabetes, it is to be understood that diabetes is only one example disease and that according to other exemplary embodiments the model may simulate the incidence and prevalence of other diseases and their C&Cs

The model can feasibly link complex and interconnected disease states, impact points, outcomes, and interventions with a variety of outcome metrics to an extent greater than existing models developed for other purposes. The model can identify priority interventions (e.g., treatments, pipeline therapies, etc.) and leverage points associated with caring for patients with diabetes and its C&Cs. The model may also provide more effective knowledge management of diverse information that is useful for formulating strategy that could be applied in a wide range of interventions, such as therapeutic applications and technology innovation uses.

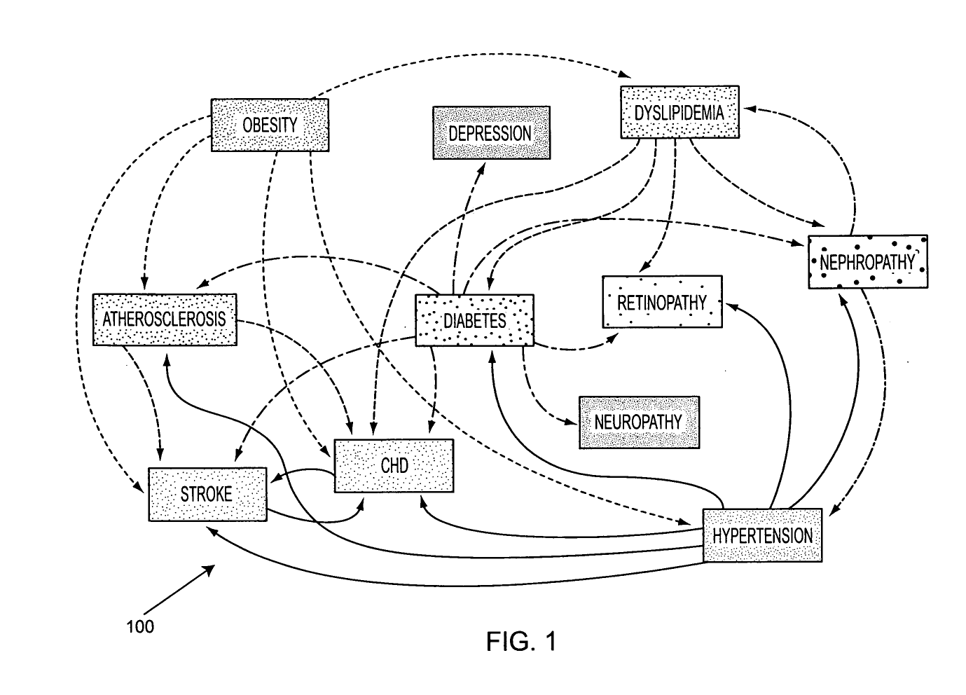

Referring to FIG. 1, according to various exemplary embodiments, Diabetes and its C&Cs can interact to form a complex feedback system 100. The cause-effect feedback loops among C&Cs may reinforce and increase the severity of the downstream C&Cs as well as diabetes itself. For example, diabetes can cause nephropathy which can increase the risk of hypertension, which can then further worsen an individual's diabetic and nephropathic state. Such self-reinforcing feedback implies that the incidence of diabetes and its C&Cs is likely to follow a non-linear, compounding, upward-curving rate of increase.

Interventions for one condition may have indirect impacts on numerous other conditions, due to the interconnected nature of a disease such as diabetes and its C&Cs. The interacting feedback loops of diabetes and its C&Cs can result in unexpected synergies and leverage points. Both the diverse nature of potential interventions and the broad impact of their indirect effects increase the likelihood of synergies among interventions, which in turn, adds to both the potential usefulness but also the complexity of assessing new interventions. This complexity is further compounded by differential impacts across subpopulations, such as subpopulations that share common complications and comorbities.

Diabetes interventions can be considered from a variety of perspectives, each with different priorities and outcomes of interest. For example, the priorities of employers may or may not align with those of providers or regulators. Perspectives of one stakeholder may change depending on the time horizon considered. Patients may or may not adhere to prescribed treatment regimes that may or may not improve quality of life. Health care payers may be more willing to pay for the short term costs of treating diabetes if they better understand the long term costs of complications of diabetes when left untreated. However, each perspective should be considered and incorporated to cohesively characterize the disease and its associated burdens. Without a cohesive consideration of diabetes, interventions may not be effectively developed or deployed to achieve the most impact. Effective use of interventions may become more important as the burden of disease increases.

Interventions (e.g., treatment technologies, therapeutic protocols, etc.) for diabetes are abundant, with hundreds more in the pipeline. With unlimited resources and time, all possible combinations of interventions could be tested and developed, but in reality, timescales and expense of technology and intervention development requires developers to be more focused on their prioritization of funding and development efforts. Even then, effective development and deployment of interventions, requires consideration of a wide range of factors, including patient age, condition severity, individual prevalence of C&Cs, health care system delivery capability, and patient usage (i.e., access to care, diagnosis rates, adherence to treatment) to fully understand the scope and magnitude of impact of the intervention on the patient. Even when limiting the evaluation to interventions or technologies aimed directly at diabetes, there are tens of thousands of combinations of patient situations and treatments to be considered, inclusion of which, together with combinations of C&Cs and their associated interventions, creates a “combinatorial explosion”. Evidence shows that humans may be very poor at intuitively evaluating influences on systems with numerous interacting feedback loops.

According to some exemplary embodiments, quantitative models provide a solution to the intervention evaluation challenge. Published models, created for diverse purposes, may fall along a spectrum of detail and information usage. According to one exemplary embodiment and at one end of the spectrum are “epidemiology-top-down” models, which emphasize prevalence data, with less emphasis on incidence data and cause and effect relations that would change prevalence over time. The derivation and structure of these models makes it difficult to quantify the direct and indirect impacts of different interventions.

According to another exemplary embodiment and at the other end of the spectrum are “physiology-bottom-up” models. Such models represent a disease in detail down to individual chemical pathways that influence biological mechanisms and for whatever variations in patient characteristics are of interest. These models have a growing track record of success in predicting outcomes for particular patients using new combinations of drugs. The scope of such models can in theory be extended to the full range of the interrelated conditions and a full range of patient population subgroups. However, the amount of physiological information required to fully populate an adequate intervention assessment model of even ten of the major C&Cs in this format seems overwhelming. Moreover, such abundant detail may also imply computational restrictions on the ability to perform adequately comprehensive exploratory analyses.

According to other exemplary embodiments, models that steer between the two ends of the spectrum aim at understanding short and long-term dynamics of patient populations in response to interventions and technologies, with neither too much detail nor too narrow a scope. For example, a model may link underlying anatomy, biological variables, care processes, and resources in a model that is being used in the management of patients.

Predicting and “managing the management” of diabetes confronts the same challenges as does intervention assessment: dynamic complexity, long delays of disease progression and the need to understand over-time impacts of ‘upstream’ and ‘downstream’ interventions. A software model of long-term diabetes response to interventions can be an input to goal-setting, performance review, and resourcing. For example, to create a “tool for enhancing learning and action” for improving public policy for chronic diseases whose impacts are recognized but not fully quantified.

According to an exemplary embodiment, the model incorporates ten C&Cs with care cycles and model structures that capture patient age, condition severity, individual prevalence of C&Cs, health care system capability, and patient usage in a simulator that can be used to identify high-value impact points in the system, high-impact interventions and high-potential synergies among interventions.

The model offers the closest match to the challenges of comprehensive intervention assessment. This method describes complex feedback systems with integral equations, and uses simulation to generate behavior from cause and effect relationships. Most importantly, the model can deal with incomplete and diverse sources of information, and diverse stakeholders, in support of decisions and actions.

Diversity extends along many dimensions: The ability to determine the risk of incidence and progression of diabetes and all of its major C&Cs, the impact of technologies and other interventions, and the complete burden of the diseases. Measurements must account for the substantial variation of risk and impact among sub-populations divided by factors such as age, gender, current health status and health history. Analysis must consider the many ways an intervention can act on conditions, including slowing progression, reducing side effects of medication, increasing patient adherence, and improving patient condition control. Metrics should be easily adapted to meet the needs of a variety of stakeholder perspectives. Moreover, model structure and parameters should be able to evolve as new information becomes available.

The modeling straightforwardly meets these challenges with the addition of an enumeration and scoring process for making the “architectural” choices of C&Cs, evidence to be used, patient subgroups, and technologies or interventions to evaluate, as described below.

In a preferred exemplary embodiment, a modeling approach is used to describe the complex feedback systems using integral equations and further use simulation to generate behavior from cause-and-effect relationships. Using a very explicit enumeration and scoring process for making the “architectural” choices of the conditions and comorbidities, evidence to be used, patient subgroups, and interventions to evaluate, the model can provide a complete evaluation of intervention effectiveness.

According to an exemplary embodiment, the modeling approach provides the ability to determine the risk of incidence and progression of diabetes and all of its major conditions and comorbidities, the impact of interventions (including technologies), and the complete burden of the diseases. Detailed measurements account for the substantial variation of risk and impact among sub-populations divided by factors such as age, gender, current health status and health history. In addition, the capability to analyze the many ways an intervention can act on conditions, including slowing progression, reducing side effects of medication, increasing patient adherence, and improving patient condition control, are included. Metrics are easily adapted to meet the needs of a variety of stakeholder perspectives. Moreover, model structure and parameters may be adjusted to evolve as new information becomes available.

According to an exemplary embodiment, the model provides the capability for analyzing and making inferences based on multiple outcome measures, including death, patient quality of life, specific disease management measure like control of HbA1c, costs, and others. The model can also link these outcome measures to broader result metrics and analyses from multiple stakeholder perspectives, including patient, physician, payer, society, technology developer, and others.

According to an exemplary embodiment, the model can also provide the capability for comprehensive, interconnected analyses that incorporate a range of health care system and management components, along with intervention-specific components. The model may enable improved disease burden forecasting linked to better mapping of interrelated clinical conditions.

According to an exemplary embodiment, causal population simulation models for evaluating portfolios of present and future technologies or other interventions for direct and indirect efficacy and impact on disease identification and progression.

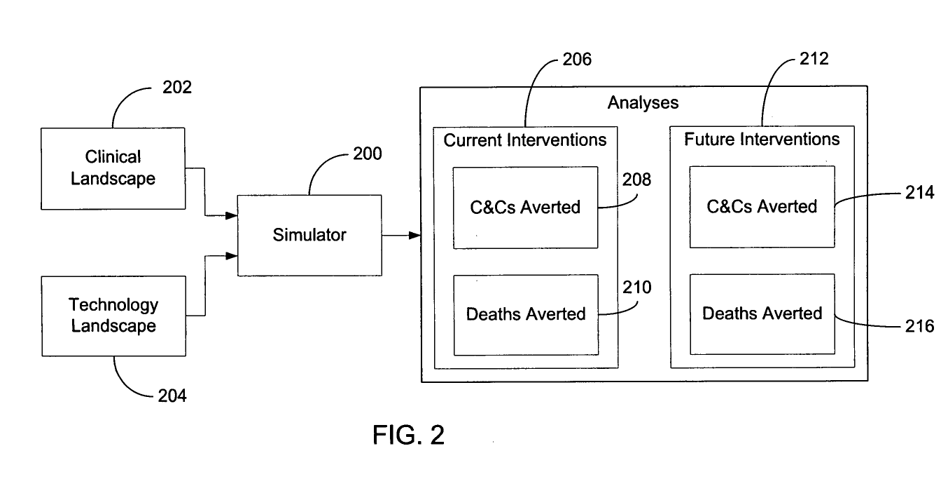

Referring to FIG. 2, an overview of the inputs and benefits of a simulator 200 is provided according to an exemplary embodiment for Diabetes. The simulator 200 receives data from a clinical landscape inventory 202 that includes data related to C&Cs and population risk factors. The simulator 200 also receives data from a technology landscape inventory 204 that includes data related to current and emerging technologies for diagnosis and treatment of a disease or ailment (e.g., Diabetes). According to various exemplary embodiments, the clinical landscape inventory 202 and the technology landscape inventory 204 may each include data stored in one or more memories, one or more databases, one or more servers, or any combination thereof. The data may be stored local to the simulator 200 or remote from the simulator 200.

Based on the inputs 202,204 the simulator 200 produces analyses 206 for the impact of current interventions. The current interventions are prioritized based on what intervention or combination of interventions may have the highest impact on averting C&Cs 208 (e.g., retinopathy) and averting deaths 210 for various population groups. The simulator 200 also produces analyses for future or emerging interventions 212. The future interventions are analyzed for impact points that may have the most impact on outcome measures of interest such as aversion of C&Cs 214 or aversion of deaths 216 for various population groups.

The analyses 206,212 provided by the simulator 200 may advantageously provide improved knowledge management, insights enabling transformation of healthcare delivery, improved insight on organizational strategy, better informed targeting and evaluation of business partners, increased productivity due to improved infrastructure, etc.

According to various exemplary embodiments, the simulator 200 may be software executed on processing electronics (e.g., a microprocessor, a server, a laptop or other computer, etc.) and/or may be hardware configured or hardwired to perform operations related to evaluation or analysis of treatment interventions (e.g., digital and/or analog electronics).

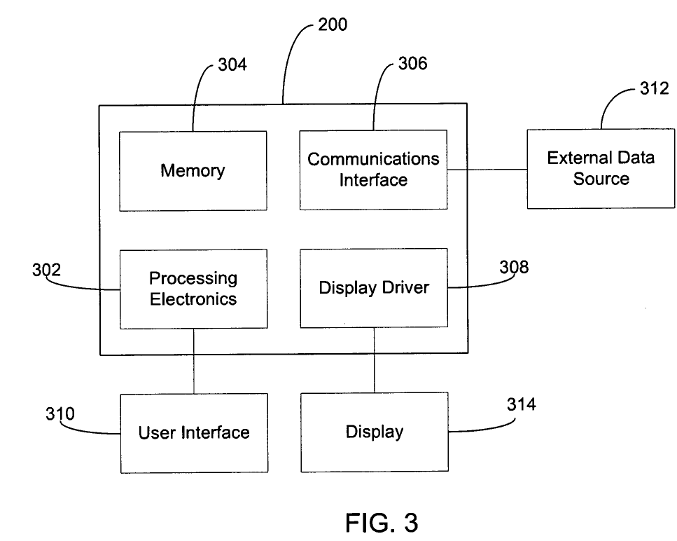

Referring to FIG. 3, the simulator 200 may include a processing electronics 302, a memory 304, a communications interface 306, and a display driver 308. The processing electronics 302 are configured to evaluate or analyze present, emerging, or future interventions (e.g., treatment technologies) for impact on diseases (e.g., diabetes) and C&Cs. The processing electronics 302 are coupled to a user interface 310 that is configured to allow a user of the simulator 200 to enter parameters, to select specific analyses, to select one or more diseases or C&Cs of interest, to select interventions, etc.

The memory 304 is generally configured to store program instructions for execution on the processing electronics 302 and/or may be configured to store data for use by the processing electronics 302 and related to diseases, C&Cs, a clinical landscape, a technology landscape, population data, risk factor data, etc. The memory 304 may be any volatile or non-volatile memory capable of storing program instructions and/or data.

The communications interface 306 is configured to communicate with an external data source 312 to receive data or commands related to evaluation of interventions. The communications interface may be configured to communicate with the external data source 312 via a USB, Firewire, serial, parallel, or any other wired connection. Alternatively, the communications interface 306 may be configured to communicate with the external data source 312 via a Bluetooth, WiFi, WiMAX, cellular, RF, or other wireless connection. According to various exemplary embodiments, the communication interface 306 may communicate with the external data source 312 over a local area network (LAN), a wide area network (WAN), the Internet, or any other network capable of transporting data related to diseases, C&Cs, and interventions.

The external data source 312 may be an external memory device, a remote computer, a server, or any other electronic data source capable of storing data related to diseases, C&Cs, a clinical landscape, a technology landscape, population data, risk factor data, etc.

The display driver 308 is configured to provide data from the processing electronics 302, the user interface 310 the memory 304m, or the communications interface 306 to a display 314 (e.g., an electronic display). For example, the display driver may provide an indication of an analyses or evaluation performed by the processing electronics 302 on the display 314.

According to various exemplary embodiments, the simulator 200 may be any computer or computing device of past, present, or future design and the simulation model may be executed on any software architecture (including Microsoft Windows, Unix, Linux, Mac OS, etc.) or with any programming language (including C/C++, BASIC, XML, etc.).

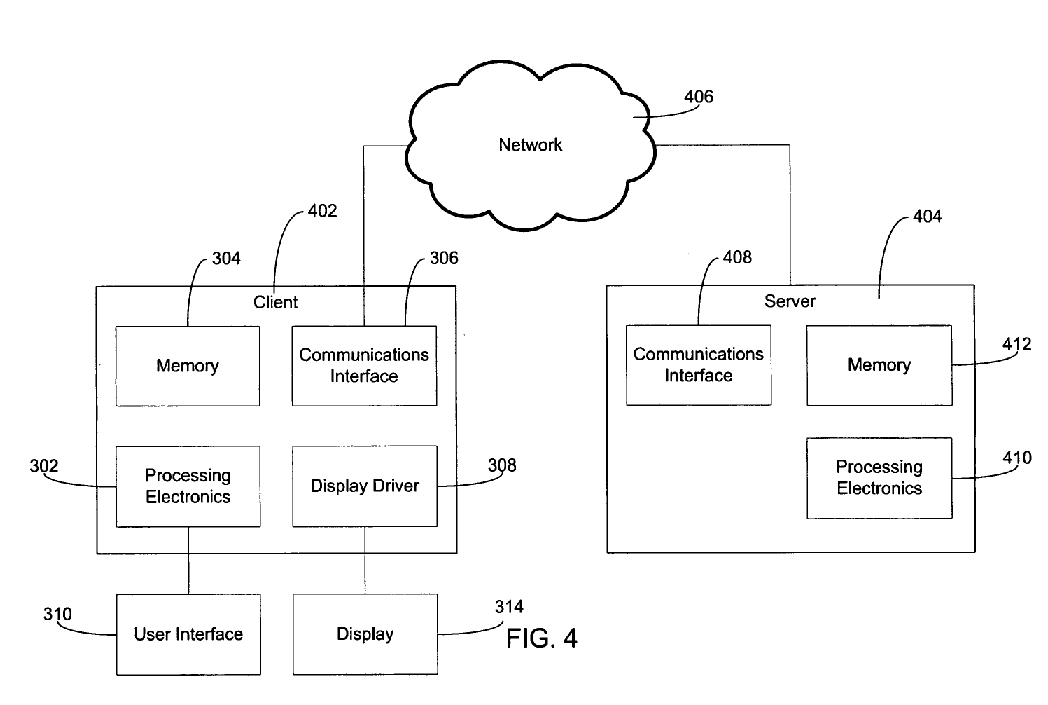

Referring to FIG. 4, according to an exemplary embodiment, the simulator 200 may be distributed across multiple computing devices 402,404 (e.g., a client and a host or server) and over a network 406 (e.g., the Internet, a LAN, a WAN, etc.). The host or server computer 404 generally includes a communications interface 408 for communicating with the client 402, processing electronics 410 for executing simulation commands or sending data to the client computer, and a memory 412 for storing the simulation commands or related data. According to one exemplary embodiment, the simulation commands or instructions may be executed on the server 404 and the results sent via the network to the 406. According to other exemplary embodiments, the server 404 may send the simulation commands to the client 402 or may be an external data source (e.g., external data source 312) for the client 402.

There are five general phases of the Proof of Principle effort of the simulator: development of a causal framework, determination of sub-populations and relative risks, structuring and calibration of the model, characterization of technology and therapeutic interventions or other interventions, and analysis of interventions.

Referring back to FIG. 1, a causal framework can be developed by organizing a disease (e.g., diabetes) and its C&Cs into strata reflecting the severity of the disease and C&C groups for proof-of-principle. Devloping the causal framework general includes a survey of the literature on the C&Cs of diabetes. Starting from an initial count of over forty, various conditions can be prioritized and aggregated into ten categories (e.g., obesity, coronary heart disease, stroke, atherosclerosis, dyslipidemia, hypertension, depression, nephrophathy, neuropathy, and retinopathy) using two criteria: the extent of population impacted and the intensity of impact of the disease. The selection may be revisited after a survey of the available studies on cause-and-effect relationships among them. The relationships among C&Cs in the model may be restricted to those with established, recognized evidence, to reduce ambiguity of results and to control complexity of model structure. The sub-classes of neuropathy, retinopathy and nephropathy may be confined to those downstream of diabetes.

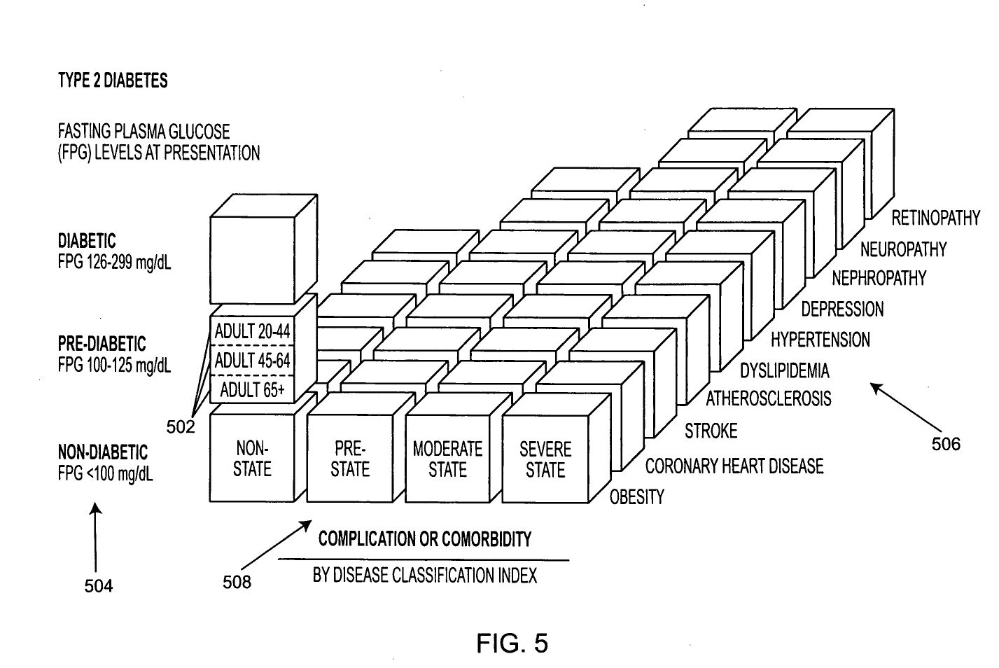

Referring to FIG. 5, in a similar process 500, clinical research can be surveyed to determine the pertinent population characteristics and relative risk values for each interrelated pair of diseases for each sub-group in the model. While many sub-population characteristics influence the relative risk of development of a one condition as a result of the presence of another, research indicated that age, diabetes severity, and complication severity may be the most influential factors, with sufficient publicly-available data to support the sub-population differences. These sub-populations can be categorized based on the data sets available in the literature: three age groups 502, three diabetic states 504, ten C&Cs 506, and four disease progression stages 508 per C&C. According to other exemplary embodiments, C&Cs 506 may include any number of C&Cs for the disease, for example 5, 15, 25, 40, etc.

Gender differences are a special case of subpopulations. The purpose of building such a model, including the proof of principle model, is to simulate impacts of interventions on the health condition of the US adult population. But to a first approximation, interventions may not be expected to alter the gender mix of the other subpopulations. Consequently, gender can be incorporated implicitly in a Proof-of-Principle model, with the option to consider gender subpopulations when the need arises, either by further dividing the model's populations, or by recalibrating the existing model to represent only the female or only the male population.

Ethnicity differences represent another special case of subpopulations. As with gender, to a first approximation, interventions may not be expected to differentially impact the ethnic subpopulations. The model can be expanded to provide further refinement of the impact of interventions on different ethnic subgroups depending on the availability of adequate data by ethnicity.

With the illustrated level of categorization, for every downstream condition, up to 360 (3×3×10×4) relative risks can be quantified using the publicly-available clinical data—often a “risk calculator” derived from large studies like the Framingham Heart Study. This dimensionality creates a practical limit on appropriate level of detail in subpopulations. Large cohort studies (>5000 people) may be a preferred data source, according to one exemplary embodiment, as they generally provide covariate-adjusted data, such as the National Health and Nutrition Examination Survey (NHANES) and the National Diabetes Surveillance System (NDSS). Publicly-available risk calculators enabled adjustment for multiple covariates as well. For example, the relative risk for CHD and stroke was determined using the University of Edinburgh Cardiovascular Risk Calculator based on the Framingham equations. When large cohort study data is incomplete or in an unusable form, data can be supplemented with assumptions based on small cohort study data (<5000 patients). For example, the South Bay Heart Watch Study evaluated risk of developing CHD in atherosclerotic diabetic patients (n=1312). In summary, the US population can be divided by age, severity of diabetes, and severity of each C&C.

It is noted that diabetes is associated with over forty complications and comorbidities and the simulator is configured or structured to accommodate each of the 40+ C&Cs. For the Proof-of-Principle effort, the breadth of this landscape may be focused to ten selected C&Cs 506. Selection of these first ten C&Cs 506 may be determined by a combination of three criteria: 1) a degree of prevalence in the population, 2) a relative uniqueness in behavior (e.g., reversibility, severity, ‘chronicity’, detectability), and 3) a diversity of impact from known, imminent interventions including technologies. Additionally, the degree of publicly available information represents a fourth and final consideration for the PoP model. Qualitative ranking of the 40+ C&Cs according to these criteria may result in the identification of the ten initial C&Cs 506 for inclusion in the simulator. These initial ten C&Cs 506 are only exemplary of what occurs for the 40+ C&Cs that would be in the simulator.

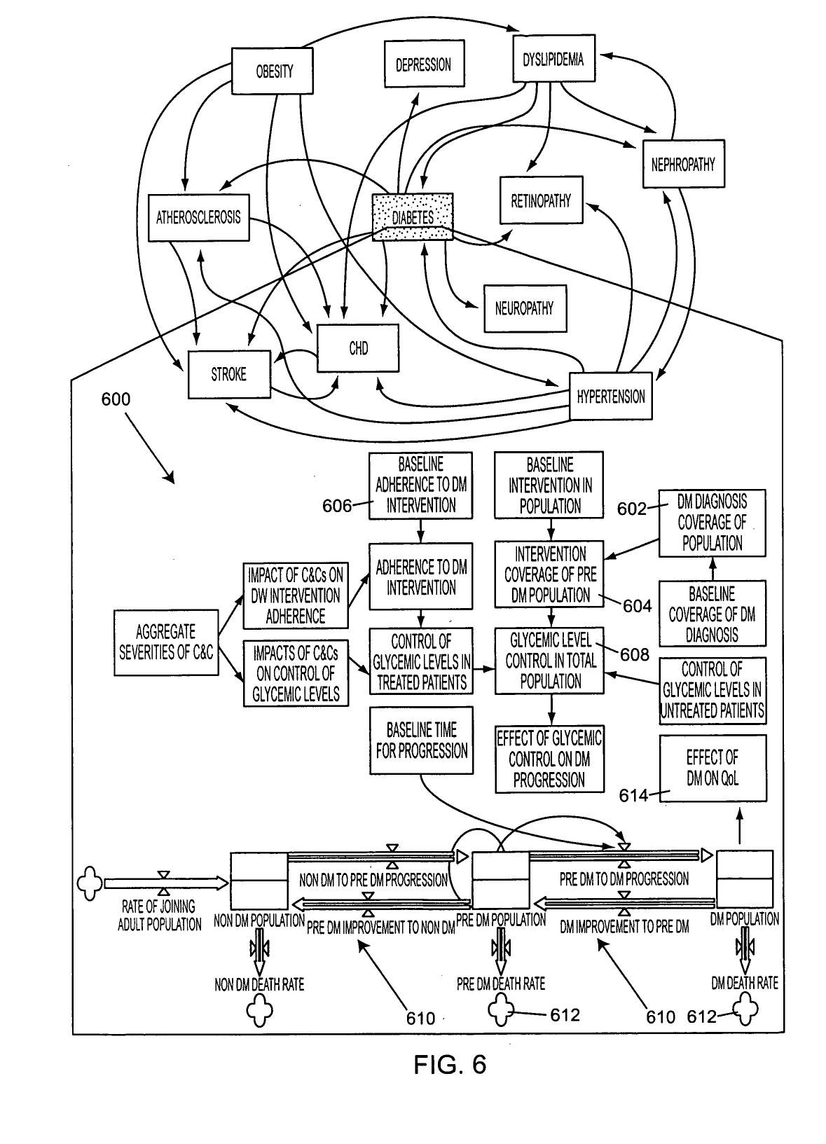

Referring to FIG. 6, the model can be structured and calibrated so each C&C of diabetes includes generally uniform patient care cycles 600 to reflect relationships among patient care variables within each condition. Subpopulations may be impacted by the rates (in persons per year) of aging, diabetes and C&C progression and fatalities. Diabetes and C&C progression are modulated both by risk factors based on incidence and the impact of patient care cycles. Patient care cycles reflect the relationships among patient care variables and each disease. The structure of patient care cycles enables quantification of the impact of changes of access to health care, initiation of appropriate treatment, patient adherence to treatment, and efficacy of treatment.

Once the progression and patient care cycle structures are established, base-case progression parameters may be used to calibrate the simulated overall prevalence of diabetes and all its C&Cs to the corresponding prevalence data time series. For both base-case progression rates and risk factors, data can be used (where it exists) that differentiates normal progression by disease severity and age. Where no empirical support for differentiation exists a uniform rate can be assumed.

As an additional validation test, the percentage per year progression rates may be held constant after a simulated year (e.g., 2007), to align the assumptions in the model with other, more epidemiological projections of diabetes prevalence, for example published epidemiological models that do not represent the dynamics of changing progression rates. The models may produce similar results with similar assumptions suggesting initial validity. Hence, the baseline model and its behavior can be validated against (i.e., constructed to be consistent with) any relevant clinical studies, risk calculators, and census and epidemiological time series data.

As an estimation procedure, the process described would be under-identified were it not for a “uniform unless proven otherwise” assumption, which removes many degrees of freedom from the estimation process. Future studies may identify and quantify some non-uniformities, but until such time as there are quantifications, testing alternative hypotheses properly lies in sensitivity testing that may be performed but not included in a base case.

A uniform methodology can be employed to quantify the impact of various interventions on diabetes and its C&Cs. A comprehensive literature survey may reveal a wide range of current and emerging interventions aimed at the treatment, monitoring, or prevention of diabetes and an even broader range when considering the ten C&Cs. For purposes of proof-of-principle, the model may quantify only the diabetes-focused interventions. These were characterized according to data available for impact at the seven points in the patient care cycle: condition progression, adherence to treatment, quality of life, access to care, access to diagnosis, mortality, and condition control (shown in FIG. 6 for an exemplary embodiment for DM at 610, 606, 614, 604, 602, 612, and 608, however the same seven components of the patient care cycle apply equally to any of the C&Cs). Most often, however, the experimental data are in terms of only the “downstream” measures of control or progression. These measures may be used to characterize the direct effect of interventions on one or more conditions in the model (e.g., How does the introduction of a non-invasive glucose monitor affect the disease progression and quality of life of the patient?). The impacts of interventions can be characterized at single loci, mostly prominently the progression rates for diabetes. This process cleanly separates the task of direct intervention impact assessment (assessed in this step) from downstream- and cross-impacts to other C&Cs (assessed by model simulation).

The patient care cycle 600 may include a number of steps corresponding various diabetes population groups (e.g., non-diabetic, pre-diabetic, diabetic) as well as progressions and death rates. The diabetes diagnosis coverage of a population (step 602) may represent a fraction of people with a condition who have not yet been diagnosed. The intervention coverage of the pre-diabetic population (step 604) may represent the fraction of diagnosed patients who do not start and/or continue their care plan due to a variety of reasons related to access to care including reimbursement issues, lack of insurance, physical access to care, providers no adequately following practice guidelines, etc. The baseline adherence to diabetes intervention (step 606) may represent the fraction of diagnosed patients who do not adhere to their care plan, thus falling short of achieving its full intended benefit. The glycemic level control in the total population (step 608) may represent the fraction of diagnosed patients who receive and adhere to their care plan without achieving the efficacy benefit according to a technologies label.

The progression and improvement arrows 610 may represent the movement from one disease severity to another, while the icons 612 generally represent mortality or death due to diabetes or a C&C. The effect of diabetes on QoL (step 614) represents the effect of diabetes on quality or non-quality of life, for example bad days, as measured by validated instruments for measuring quality of life.

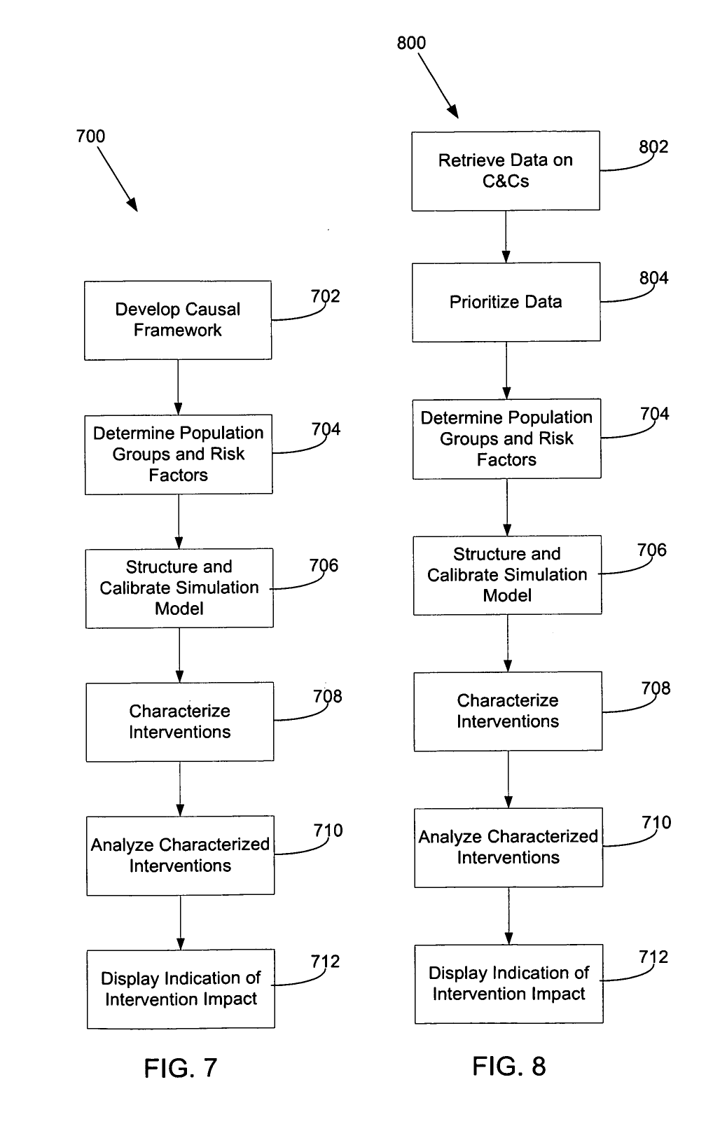

Referring to FIG. 7, a method 700 evaluates one or more interventions using processing electronics, such as simulator 200. Each of the interventions may have a direct or indirect impact on a disease identification or a disease progression. The method 700 includes developing a causal framework to establish relationships among the disease, complications of the disease, and comorbidities of the disease (step 702). The relationships are generally based on information retrieved from at least one electronic data source (e.g., external data source 312, clinical landscape 202, technology landscape 204, etc.).

The method 700 determines population groups and risk factors for the disease, complications of the disease, and comorbidities of the disease (step 704). The population groups and risk factors are generally based on information retrieved from the at least one electronic data source.

The method 700 structures and calibrates a simulation model (e.g., on simulator 200) of the relationships, population groups, and risk factors (step 706). The method 700 characterizes interventions based on information retrieved from the at least one electronic data source. The method 700 also analyzes the characterized interventions to determine the direct or indirect impact of the interventions on the disease identification or progression using the simulation model. The method 700 then provides an indication of the impact of the interventions on an electronic display, for example display 314.

Referring to FIG. 8, a method 800 is similar to the method 700 of FIG. 7, however the step of developing the causal framework includes retrieving data on complications and comorbities of diabetes from the at least one electronic data source (step 802). In this case, the disease is specifically related to diabetes. The development of the causal framework also includes prioritizing the data on complications and comorbities of diabetes into multiple categories based on an extent of a population impacted and an intensity of an impact of the disease (step 804), for example as shown in FIG. 1.

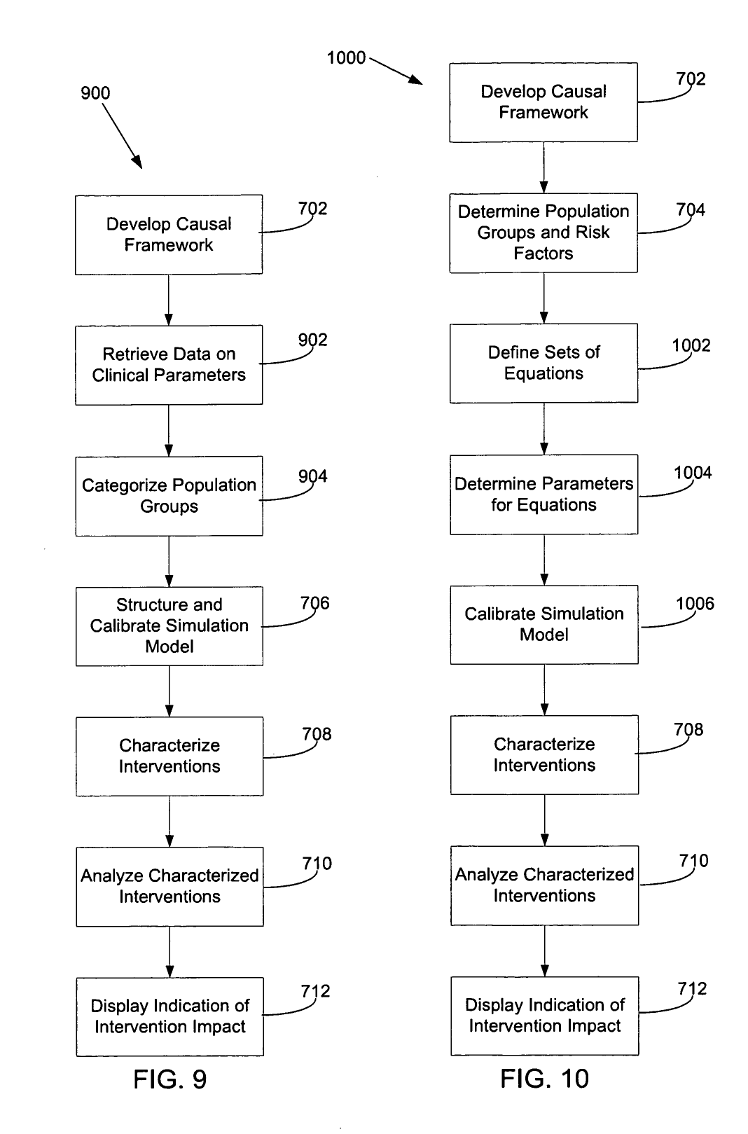

Referring to FIG. 9, a method 900 is similar to the method 700 of FIG. 7, however the step of determining the population groups and risk factors includes retrieving data on clinical parameters to determine one or more pertinent population characteristics and risk values for each of an interrelated pair of diseases, complications, or comorbidities for each population group (step 902) and categorizing the population groups based on the data into multiple age groups, multiple diabetic states, multiple complications and comorbidities, and multiple disease identification and progression stages per condition and comorbidity (step 904), for example as shown in FIG. 5.

Referring to FIG. 10, a method 1000 is similar to the method 700 of FIG. 7, however the step of structuring and calibrating the population simulation model includes defining sets of equations for modeling disease identification and progression (step 1002), determining one or more parameters for the sets of equations, the parameters based on multiple risk factors (step 1004), and using base-case progression parameters to calibrate a simulated overall prevalence of diabetes and complications and comorbidities to a corresponding prevalence data time series (step 1006), for example as shown in FIG. 6.

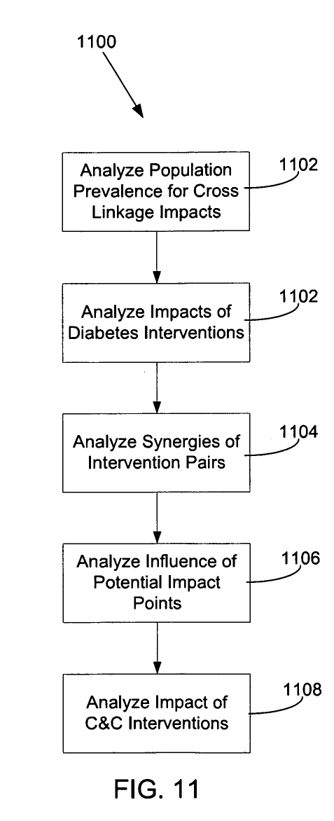

Referring to FIG. 11, an analysis plan 1100 of the interventions generally includes demonstration of various types of generic intervention assessment analyses with five main categories:
1. Base case future population/sub-population prevalences demonstrating the impacts of disease cross-linkages (step 1102)
2. Relative impacts of diabetes-related interventions by chosen metrics (step 1104)
3. Synergies created by diabetes-related intervention pairs (step 1106)
4. Relative influence of potential diabetes intervention impact points in order to help drive the search for the most beneficial interventions (step 1108)
5. Impact, by pathway and source, of interventions treating C&Cs on the chosen metrics (step 1110)

Such analyses revolve around the definition of an outcome that matters to the decision maker. Given the level of detail in the model, it may be straightforwardly possible to examine multiple measures of outcome, including measures of cost, disease progression, and patient quality of life, in the aggregate and by subpopulation, if appropriate data are available. However, given the proof-of-principle end-point of this effort and data challenges, the analyses may use “deaths averted” as a primary outcome metric.

For most relationships, the standard relative risk quantification specifies a causal relationship: The presence of condition X multiplies the ceteris paribus incidence of Y by the relative risk RR. There are two special cases that may require modification to the relative risk concept. First, for diabetic nephropathy, diabetic retinopathy and diabetic neuropathy, ceteris paribus incidence in the absence of diabetes is zero. So for these conditions “baseline risk” is the presence of the average diabetic condition is the incidence of each “x-opathy” over a single year. Second, for diabetes, what influences risk of other conditions is not the presence of an underlying inherent condition of inability to control blood glucose, but rather the effectiveness of control (or lack thereof) of blood glucose. To be consistent with available studies, out of control patients were defined using HbA1c as percentage of each patient subpopulation with HbA1c in control.

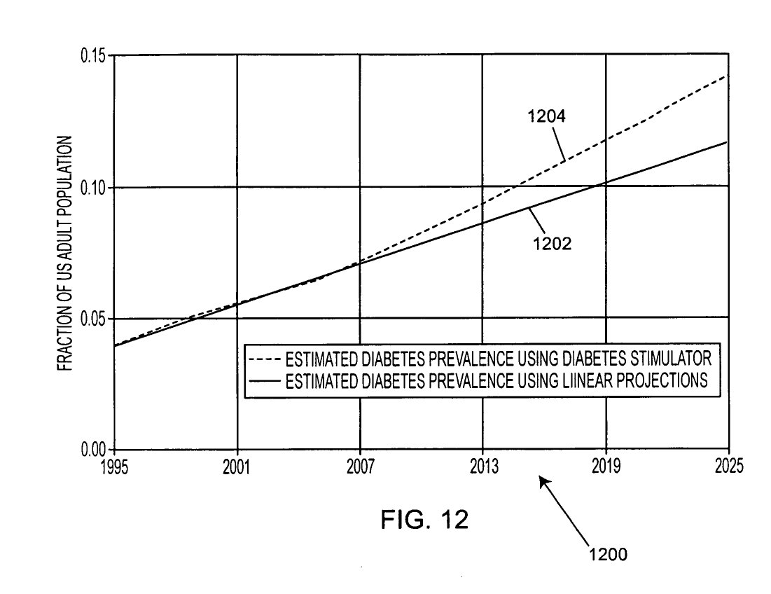

Referring to FIG. 12, a behavior 1200 of the model with feedback relationships among diabetes and its C&Cs, when calibrated to past data, may show future prevalence of diabetes and C&Cs increasingly curving upward above those indicated by other studies. The simulation steps through each quarter year, beginning in 1995 (to allow comparison to historical prevalence data) and ending in 2025 (to show long-term behavior and intervention impacts). A projection 1202 that assumes linear effects of C&Cs on dabetes prevalence show some impact from C&C prevalence changes. Alternatively, a base case model 1204 simulated with simulator 200 shows influence of “vicious circles” among diabetes and its C&Cs demonstrating impact of cross-linkages. Such a chart may be displayed as the indication of analysis on display 314.

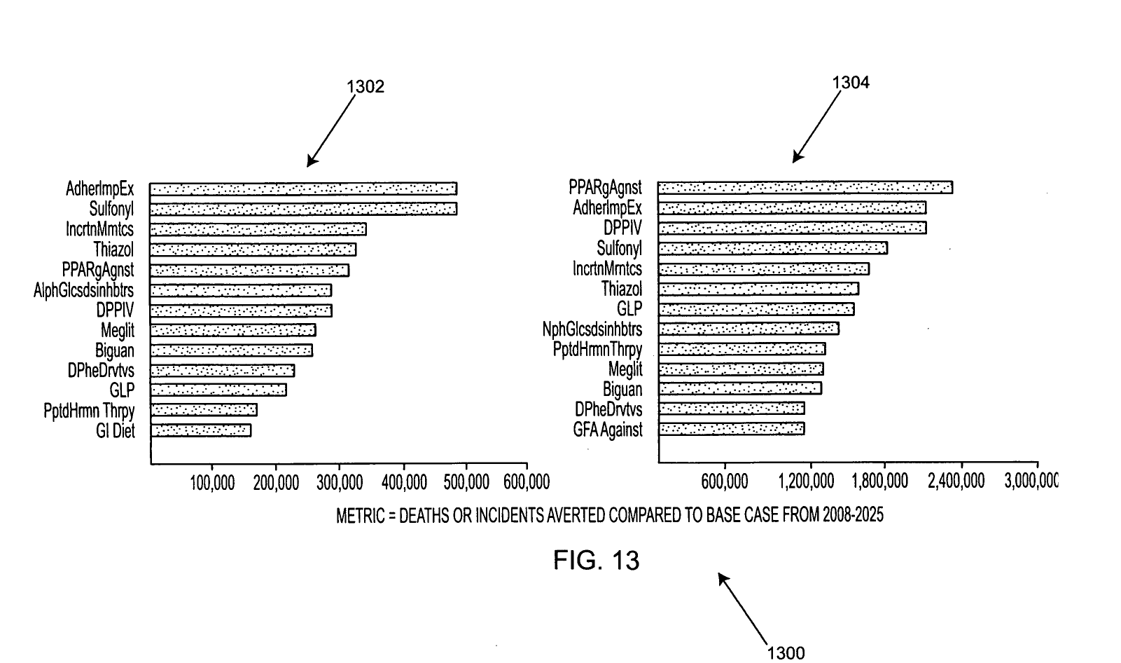

Referring to FIG. 13, an illustrative analysis 1300 ranks intervention impacts and clinical impact points. The results indicate the importance of choice of outcome measure. The interventions rankings by deaths 1302 averted and retinopathy cases averted 1304 vary, highlighting the influence of the outcome measure on the rankings. The outcome measure is determined by the perspective of interest, generating a intervention ranking specific to the interests of that perspective and highlighting differences in priorities based on perspective and outcome of interest. Such a ranking may be displayed as the indication of analysis on display 314.

In terms of generic care structure variables, national averages may be used as baseline throughout. Given that the primary uses are simulating effects of changes in these variables (illustrated below) rather than absolute quantities, the expectation may be that subpopulation-specific variations materialize through variations in progression rates, and that to first order, the blanket characterization does not distort the experimental results.

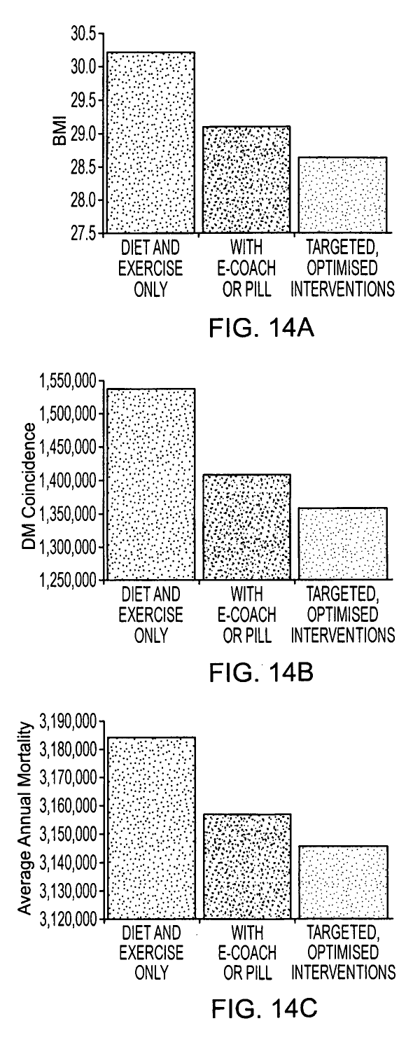

Referring to FIGS. 14A-14C, an illustrative analysis around adherence issues demonstrates the benefits of targeting appropriate interventions by subgroup. Patient adherence to prescribed medication continues to be an area of notable unmet need with numerous opportunities for meaningful intervention, resulting in a significant opportunity to improve outcomes. Numerous drivers influence adherence (from reimbursement issues to drug dosage regimen complexity), and these drivers interact in complex ways. In order to quantify the impact of targeted subgroups, three additional dimensions not represented in the base model can be added by utilizing three hypothetical dimensions to characterize population subgroups: insurance status, high-low discipline, and high-low family responsibilities, for a total of eight subpopulations. Comparing two illustrative adherence interventions (an e-coach and a diet medication), if treatment with either of them blankets the entirety of the diabetic population, by assumption each would raise the overall population adherence rate from the baseline adherence rate of 33% to 40%. Within that population average, however, are particular subpopulations with much lower adherence, due to the adverse cases of the three dimensions (no insurance, no discipline, high family responsibilities). By targeting specific subgroups, population adherence may be increased to about 44%, as opposed to rising to only about 40% in either of the blanket intervention cases. Such charts may be displayed as the indication of analysis on display 314.

For simplicity of illustration, the adherence analysis assumes equal populations in each of the eight subpopulations. For each of the eight subpopulations, the model is parameterized to the assumptions for that subpopulation, and the blanket versus targeted simulations performed. Results from the eight pairs of simulations are added up to population-wide totals for, e.g. obesity and diabetes prevalence and mortality.

The small increase in adherence may have significant impacts in the future. Referring specifically to FIG. 14A, comparing the “blanket intervention” cases to targeting the right intervention to each subgroup, population average BMI is lowered to 28.7 from 30.2, a 30% reduction in the original obesity prevalence by 2025. Referring specifically to FIG. 14B, the lower obesity also led to a 12% drop in Type 2 diabetes cases. Referring specifically to FIG. 14C, the lower obesity targeting impacts mortality as well. Without targeting, the decrease in complications as a result of lower obesity may save about 27,000 lives per year (just under 1% of the total annual mortality). With sub-group targeting, adherence interventions can save an additional 11,000 lives per year, which constitutes a 40% increase in the (mortality) impact of the interventions.

This analysis exemplifies the more general expectation that major impacts are to be found within the complexities of the diabetes and C&Cs system, if there is an analytical tool to lend both rigor and speed to the exploration.

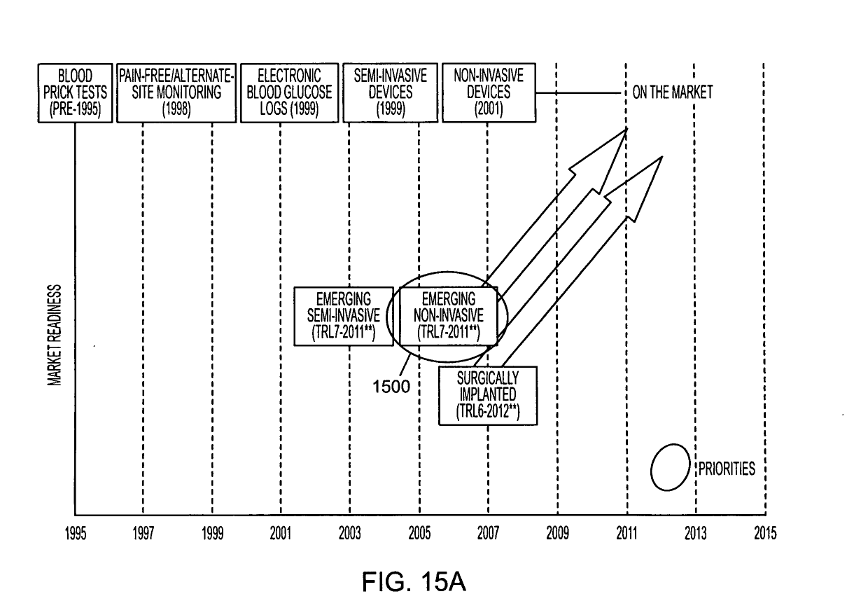

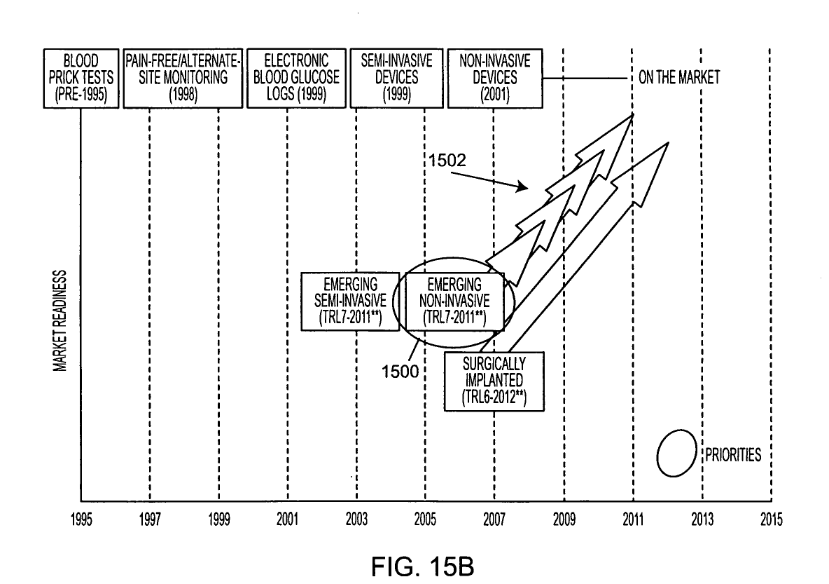

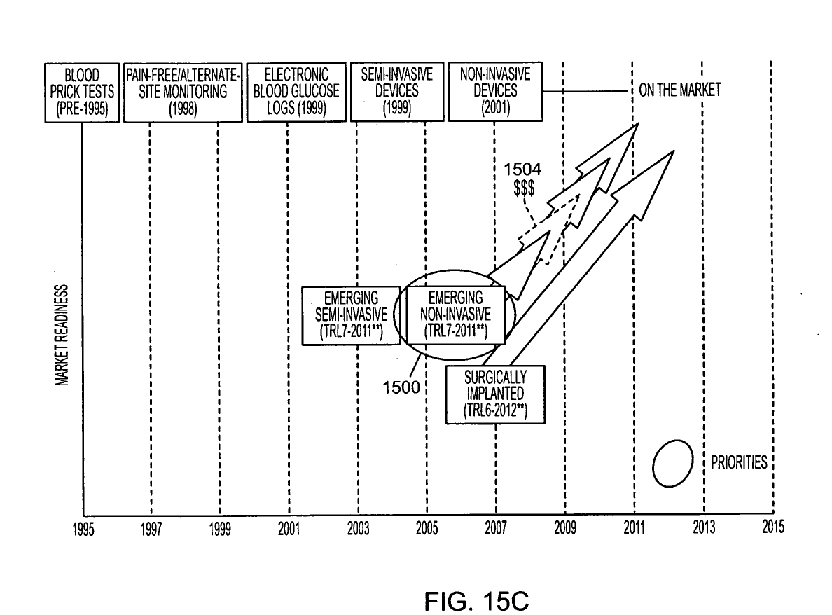

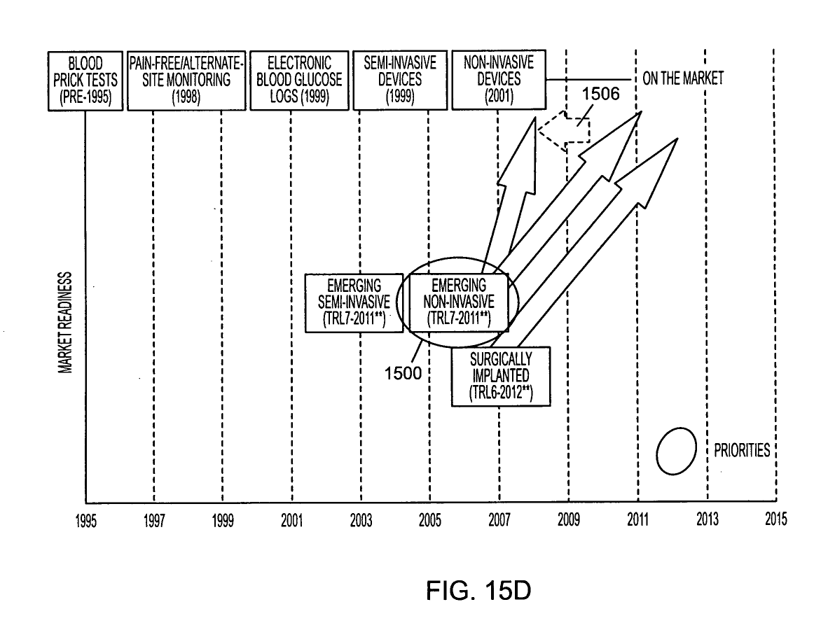

Referring to FIGS. 15A-15D, a number of charts illustrate how identification of high-impact interventions (including technologies) and their associated investment opportunities can enable acceleration of the trajectory of emerging interventions including technologies. Referring specifically to FIG. 15A, priority technologies (e.g., emerging non-invasive technology 1500) can be identified using the impact ranking of technologies provided by the model simulator 200. Referring specifically to FIG. 15B, the steps 1502 required to bring the high-priority technology to market can then be determined. Referring specifically to FIG. 15C, high-impact investment opportunities 1504 can then be identified that would accelerate time to market, including analyses of competitor responses. Referring specifically to FIG. 15D, high impact, priority technologies can then be brought to market faster (step 1506).

Three exemplary embodiments or scenarios for the model are described below to further describe the analyses performed by the model(e.g., base case projections, intervention impact, and leverage testing) as well as different perspectives or consideration used by the model (e.g., advocacy organization, insurance company, pharmaceutical) to illustrate a range of applications and users.

According to a first exemplary embodiment, the simulator can make base case projections using calibrated data. For example, the user may be a national diabetes-related advocacy organization with a goal of forecasting the disease prevalence of diabetes and its related C&Cs using a calibrated base case projection.

The simulator can be calibrated using the best available data on historical prevalence by disease including using the publicly-available data currently built into the model and can also include private data provided by the advocacy organization. Future projections can be generated that incorporate the feedback loops inherent to diabetes and its C&Cs based on public and private data inputs and associated calibration data.

Traditional approaches typically do not incorporate the feedback loops among diabetes and its C&Cs and as such may be underestimating future prevalence. Furthermore, the model of this disclosure can be used to develop subpopulation-specific projections (e.g., by age or other patient/disease characteristics). For example, it is possible to consider individual specific population profiles (e.g., the population of 20-44 year old obese pre-diabetics over time).

Inputs for entering calibration data into the simulator represent unique data relevant to the particular situations of interest. The range of relevant calibration data can include everything from more accurate or granular data from private sources to specific risk ratio data on subpopulations split by ethnicity. The ability to calibrate the simulator against different subpopulations enables wider application of the model without massive expansion of the underlying model architecture. The simulator can provide outputs (e.g., to a display or memory device) indicating prevalence of disease populations over time, both as a whole and by subpopulation of interest.

According to another exemplary embodiment, the simulator can be configured to make intervention impact analyses. For example, the user may be an insurance company with a goal of reducing costs by improving patient health through improvements in adherence to treatment interventions and by analyzing the impacts of treatment technologies. Non-adherence to treatment interventions can lead to declining health of a patient and declining health generally leads to increased health insurance costs. Improving adherence to treatment interventions can reduce the decline in health from non-adherence. The insurance company can reduce health insurance costs by identifying and supporting (either directly or indirectly) technologies to improve adherence. The simulator can be used to prioritize the degree to which technologies impact adherence.

The underlying motivations of adherence (and non-adherence) are inherently personal and subject to variations across different subpopulations. These subpopulations can be split across any number of factors (e.g., age, ethnicity, socioeconomic circumstances, specific lifestyle characteristics, etc). Because the underlying motivations for adherence vary across these subpopulations, the efficacy and effectiveness of different interventions intended to improve adherence can vary dramatically across these subpopulations. The simulator can be used to determine which interventions are most appropriate for improving adherence for specific subpopulations through a more effective personalized approach than traditional approaches.

The inputs to the simulator for analysis are the inputs used to conduct impact analyses of specific technologies or interventions. By their nature, inputs for analysis are impact profiles of interventions including technologies (e.g., profiles of where in the model, interventions influence), risk ratios across the subpopulations of interest (e.g., for subpopulations of age—risk ratios across each of the age groups—generally included in base case projection above and any additional ones that would be relevant to the intervention, including technologies, of interest), timescales of interest, and/or where in the model (i.e., what impact points) and to what degree (on what order of magnitude) does each intervention of interest impact a parameter (e.g., access to care).

The output of the simulator (e.g., a display, storage in a memory device) indicates outcome measures of interest (e.g., adherence directly, disease prevalence over time over baseline, etc) for each scenario (e.g., split by subpopulation) and for each intervention. The relative magnitude of impact on the outcome metric can be compared to determine the best intervention (either existing or emerging) by subpopulation to improve adherence. The simulator may also output an identification of emerging technologies that could be accelerated with investment based on relative impacts on outcomes of interest.

According to another exemplary embodiment, the model can be configured to provide a point impact analysis. For example, the user may be a pharmaceutical company with a cardiovascular (CV) based product line and have a goal of expanding the business into a new therapeutic area by determine the therapy area with the most potential. The simulator can be used to evaluate and compare which therapy areas would be the most synergistic with the CV pharmaceutical company's current product line.

The current product line can be categorized in terms of relative impact on ‘levers’ within the model (e.g., its statin reduces the likelihood of another cardiac event by a factor of 5) and the relative impact of each product can be overlaid onto the model, building their impact on levers directly into the model structure in the adjusted risk ratio relationships that represent the levers. Outcome measures of interest can be defined in terms of patient outcomes, mortality, variables specific to CV, etc. A leverage impact analysis can be conducted to determine which leverage points within the model, when changed, have the largest impact on the outcome measures of interest. The leverage impact analyses can incorporate sensitivity analyses that consider the variable impact at different degrees of change. The leverage impact analyses can be conducted separately for a number of outcome measures to develop a comprehensive landscape of the varying potential of different therapeutic areas. Traditional evaluation approaches do not comprehensively incorporate the potential synergies among the existing product line and the potential areas of development

The inputs of the simulator include inputs for analysis, for example an impact profile of a current product line on leverage points within the model. The simulator outputs (e.g., displays, stores, etc.) leverage points within the system of therapeutic areas that, if influenced, would have the largest impact on outcome measures of interest. A series of analyses across a variety of outcome measures can be used to develop a more comprehensive view of which therapeutic areas have the most potential in light of the company's current product line.

The importance, urgency, and complexity of the growing burden of diabetes and obesity require strategic quantification of the clinical, economic, and social challenges of diabetes and its C&Cs. Existing clinical data can be integrated into a cohesive structure reflecting the full interconnectedness of diabetes and its C&Cs. The simulator 200 and processes allow for more extensive and comprehensive technology and intervention choices and evaluation of healthcare alternatives.

The modeling process may also include a combination of model extensions and refinements. The intervention characterization and analysis can be extended to cover the C&Cs as well as diabetes. Refinements can include additional data and detail for C&Cs, lifestyle variables, health system variables, and additional output metrics, particularly around cost of treatment, because they are central for many key stakeholders. Missing and diffused data poses one of the biggest challenges and limitations of comprehensive modeling efforts. Furthermore, unknown predicted efficacy and effectiveness of future interventions, including technologies, adds further complexity. In response to these challenges, the model can analyze and prioritize which data would be most decisive for a given question, so that scarce resources could focus on the information that matters most. With a sharper analytical focus, the various large cohort studies or clinical trials may yield additional quantifications in areas that matter most.

Although, the model may not by itself reduce the notable burden of chronic disease care in an aging population, without the ability to quickly explore new ways of dealing with the problem, the health care system may continue to explore new interventions including technologies on an ad hoc basis, establishing a pace of change that may have a detrimental effect to improvement of patient well-being and health care expenditures.

The foregoing description includes what is at present considered to be the preferred embodiment of the invention. However, it will be readily apparent to those skilled in the art that various changes and modifications may be made to the exemplary embodiments within the same overall architecture and scope of the invention. For example, the number and type of conditions and conditions and comorbidities may be varied, along with the sources and types of supporting data. Accordingly, it is intended that such changes and modifications fall within the spirit and scope of the invention as recited in the following claims.

While the exemplary embodiments illustrated in the Figures and described above are presently preferred, it should be understood that these embodiments are offered by way of example only. Accordingly, the present disclosure is not limited to a particular embodiment, but extends to various modifications that nevertheless fall within the scope of the description. The order or sequence of any processes or method steps may be varied or re-sequenced according to alternative embodiments.

Describing the invention with Figures should not be construed as imposing on the exemplary embodiments any limitations that may be present in the Figures. The present disclosure contemplates methods, systems and program products on any machine-readable media for accomplishing its operations. The embodiments of the present disclosure may be implemented using an existing computer processors, or by a special purpose computer processor for an appropriate vehicle system, incorporated for this or another purpose or by a hardwired system.

As noted above, embodiments within the scope of the present disclosure include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the diagrams herein may show a specific order of method steps, it is understood that the order of these steps may differ from what is depicted. Also two or more steps may be performed concurrently or with partial concurrency. Such variation will depend on the software and hardware systems chosen and on designer choice. It is understood that all such variations are within the scope of the invention. Likewise, software implementations of the present invention could be accomplished with standard programming techniques with rule based logic and other logic to accomplish the various connection steps, processing steps, comparison steps and decision steps.

The foregoing description of embodiments of the disclosure has been presented for purposes of illustration and description. It is not intended to be exhaustive or to limit the invention to the precise form disclosed, and modifications and variations are possible in light of the above teachings or may be acquired from practice of the disclosure. The embodiments were chosen and described in order to explain the principles of the invention and its practical application to enable one skilled in the art to utilize the disclosure in various embodiments and with various modifications as are suited to the particular use contemplated.

What is claimed is:

1. A method for evaluating one or more interventions using processing electronics, each of the interventions having a direct or indirect impact on a disease identification or a disease progression, the method comprising the steps of:
developing a causal framework to establish relationships among the disease, complications of the disease, and comorbidities of the disease, the relationships based on information retrieved from at least one electronic data source;
determining population groups and risk factors for the disease, complications of the disease, and comorbidities of the disease, the population groups and risk factors based on information retrieved from the at least one electronic data source;
structuring and calibrating a simulation model of the relationships, population groups, and risk factors;
characterizing interventions based on information retrieved from the at least one electronic data source;
analyzing the characterized interventions to determine the direct or indirect impact of the interventions on the disease identification or progression using the simulation model; and
providing an indication of the impact of the interventions on an electronic display or memory device.

2. The method of claim 1, wherein the step of developing the causal framework further comprises the steps of:
retrieving information on complications and comorbities of the disease from the at least one data source; and
prioritizing the data on complications and comorbities of the disease into multiple categories based on an extent of a population impacted and an intensity of an impact of the disease.

3. The method of claim 1, wherein the step of determining the population groups and risk factors further comprises the steps of:
retrieving data on clinical parameters to determine one or more pertinent population characteristics and risk values for each of an interrelated pair of diseases, complications, or comorbidities for each population group; and
categorizing the population groups based on the data into multiple age groups, multiple diabetic states, multiple complications and comorbidities, and multiple disease identification and progression stages per condition and comorbidity.

4. The method of claim 1, wherein the step of structuring and calibrating the population simulation model further comprises the steps of:
defining sets of equations for modeling disease identification and progression;
determining one or more parameters for the sets of equations, the parameters based on multiple risk factors; and
using base-case progression parameters to calibrate a simulated overall prevalence of the disease and complications and comorbidities to a corresponding prevalence data time series.

5. The method of claim 1, wherein the step of characterizing the interventions further comprises characterizing according to data available for impact at multiple points in a patient care cycle.

6. The method of claim 1, wherein the step of analyzing the characterized interventions further comprises the steps of:
analyzing base case future population and population group prevalence for impacts of cross-linkages;
analyzing impacts of disease treatments using predetermined metrics;
analyzing synergies created by disease intervention pairs;
analyzing influence of potential disease intervention impact points to aid in retrieving the most beneficial interventions; and
analyzing the impact of interventions for treating complications and comorbidities on the predetermined metrics using source and causal pathways through disease states of the population.

7. The method of claim 1, further comprising the step of analyzing and making inferences based on multiple outcome measures including death, patient quality of life, specific disease management measures, and costs.

8. The method of claim 1, further comprising the step of linking outcome measures to analyses from multiple stakeholder perspectives including patient, physician, payer, society, intervention developer, and/or technology developer.

9. The method of claim 1, further comprising the steps of:
providing comprehensive interconnected analyses that incorporate a range of health care system and management components along with intervention specific components; and
linking disease burden forecasting to better mapping of interrelated clinical conditions.

10. An integrative simulation model architecture for representing the health status of a patient population with respect to multiple disease conditions, complications, and comorbidities, comprising:
a data source configured to store information related to disease conditions and associated complications, and comorbidities; and
a simulator configured to retrieve information stored on the data source and use the information to evaluate one or more interventions using processing electronics to determine a direct or indirect impact on a disease identification or a disease progression, the simulator storing an indication of the impact of the interventions on a memory device or providing an indication of the impact of the interventions to an electronic display.

11. The integrative simulation model architecture of claim 7, wherein the simulator is configured to formulate a causal framework to establish relationships among the disease, complications of the disease, and comorbidities of the disease.

12. The integrative model architecture of claim 7, wherein the simulator is configured to perform the evaluation using an aggregate population, continuous-time model.

13. The integrative simulation model architecture of claim 7, wherein the simulator is configured to represent a population with regard to progression of each of multiple complications and comorbidities of the disease in combination with the progression of the disease.

14. The integrative simulation model architecture of claim 7, wherein the simulator is configured to model population groups for the disease complications and comorbidities.

15. The integrative simulation model architecture of claim 7, wherein the simulator is configured to determine parameter values derived from relative risk ratio data of the complications and comorbidities.

16. The integrative simulation model architecture of claim 7, wherein the simulator is configured to model disease identification and progression using diagnosis timing and coverage, treatment timing and coverage, and/or adherence.

17. The integrative simulation model architecture of claim 7, wherein the simulator is configured to determine parameter values derived from evidence-based medicine results concerning medical system behavior based on estimation theory for stochastically-observed dynamic systems.

18. The integrative simulation model architecture of claim 14, wherein the evidence-based medicine results comprise screening, health/disease identification, diagnosis, treatment, treatment monitoring, patient adherence, disease progression monitoring, and/or outcome identification.

19. The integrative simulation model architecture of claim 7, wherein the simulator is configured to calibrate parameter values to match simulated and measured actual disease prevalence.

20. The integrative simulation model architecture of claim 7, wherein the simulator is configured to categorize interventions and quantify future impacts in combination with existing interventions.

21. The integrative simulation model architecture of claim 7, wherein the simulator is configured to provide a representation of an impact of an intervention on lifestyle.

22. A simulator for evaluating one or more interventions to determine a direct or indirect impact on a disease identification or a disease progression, comprising:
processing electronics configured to receive information from a data source and provide an indication of the direct or indirect impact to a memory device or display; and
wherein the processing electronics are configured for evaluating direct and indirect consequences of interventions on overall patient population disease status, evaluating medical impacts on overall patient population disease status of future intervention developments, and evaluating impacts on overall patient population disease status of alternative demographics for a given intervention and determining differential impacts of interventions.

23. The simulator of claim 19, wherein the processing electronics are further configured to characterize population responses to, and likelihood of, complications and comorbidities for clinical research design.

24. The simulator of claim 19, wherein the processing electronics are further configured to characterize population responses to, and likelihood of, complications and comorbidities for clinical trial design appropriate to new interventions.

25. The simulator of claim 19, wherein the processing electronics are further configured for characterizing population responses to, and likelihood of, complications and comorbidities as a key element in analysis of medical system cost and benefit of alternative interventons.

26. The simulator of claim 19, wherein the processing electronics are further configured for receiving both relative risk ratio data and prevalence data, the risk ratio data and prevalence data comprising data on medical cause and effect such as condition-controlled statistical risk ratios and data on prevalence of a medical condition of a population or subpopulation typically resulting from epidemiological research.

27. The simulator of claim 19, wherein the processing electronics are further configured for evaluating consequences on overall patient population disease status of multimodal interventions given data or plausible assumptions about medical interactions within patient types.

28. The simulator of claim 19, wherein the processing electronics are further configured for providing a representation of an impact of interventions on adherence.

29. The simulator of claim 19, wherein the processing electronics are further configured for providing a representation of interventions that change the timing and certainty of diagnosis, such as in early stages of a disease.

30. The simulator of claim 19, wherein the processing electronics are further configured for providing a representation of an impact of interventions on the nature of screening diagnosis and treatment, such as promptness and completeness.
